(19) United States
(12) Patent Application Publication
(10) Pub. No.: US 2008/0254746 A1
(43) Pub. Date: Oct. 16, 2008

(54) VOICE-ENABLED HANDS-FREE TELEPHONE SYSTEM FOR AUDIBLY ANNOUNCING VEHICLE COMPONENT INFORMATION TO VEHICLE USERS IN RESPONSE TO SPOKEN REQUESTS FROM THE USERS

(75) Inventors: Sumithra Krishnan, Canton, MI (US); Jason G. Bauman, Huntington Woods, MI (US); Jody K. Harwood, Plymouth, MI (US); Kenan R. Rudnick, Bloomfield Hills, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/734,953

(22) Filed: Apr. 13, 2007

(51) Int. Cl. H04B 7/00

(52) U.S. Cl. 455/66.1

(57) ABSTRACT

A voice-enabled, hands-free telephone system includes an appliance, speakers, and a component connected to a communications bus of a vehicle. The component provides to the bus a signal indicative of a condition monitored by the component. During a call between a user using a Bluetooth enabled phone and another party the appliance wirelessly communicates voice signals from the user to the phone for transmission to the party and the appliance wirelessly receives voice signals of the party from the phone and outputs these signals to the speakers via the bus for the user to hear. In response to the user speaking a request for the status of the condition, the appliance obtains the component signal from the bus to determine the status of the condition and audibly announces a computerized voice signal indicative of the status of the condition through the speakers via the bus for the user to hear.

### BACKGROUND OF THE INVENTION

1. Field of the Invention

The present invention relates to hands-free telephone systems for use with vehicles.

2. Background Art

A hands-free telephone system enables a user to talk on a cell phone while using both hands to drive a vehicle. Some hands-free telephone systems are voice enabled. Such systems include a voice recognition module (VRM) which enables the user to answer and make phone calls and re-dial numbers using voice commands instead of handling the cell phone to do the same.

### SUMMARY OF THE INVENTION

An object of the present invention includes a voice-enabled hands-free telephone system for a vehicle in which the system audibly announces vehicle component information through speakers of the vehicle for a user to hear in response to a spoken request for such information from the user.

Another object of the present invention includes a voice-enabled hands-free telephone system for a vehicle in which the system audibly announces information pertaining to the current vehicle direction, the temperature outside the vehicle, the time, and/or the vehicle speed through vehicle speakers for a user to hear in response to a spoken request for such information from the user.

A further object of the present invention includes a voice-enabled hands-free telephone system for a vehicle in which the system includes a voice recognition module (VRM) to receive a spoken request for vehicle component information from a user and then the system audibly announces such information through vehicle speakers for the user to hear.

Another object of the present invention includes a voice-enabled hands-free telephone system for a vehicle in which the system includes a voice synthesizer to audibly announce vehicle component information through vehicle speakers for a user to hear in response to receiving a spoken request for such information from the user.

A further object of the present invention includes a voice-enabled hands-free telephone system for a vehicle in which the system obtains status information from a vehicle component via the communication bus of the vehicle in response to a spoken request for such information from a user and audibly announces the information through vehicle speakers for the user to hear.

Another object of the present invention includes a voice-enabled hands-free telephone system for a vehicle in which the system audibly announces vehicle component information through vehicle speakers via the communication bus of the vehicle for a user to hear in response to a spoken request for such information from the user.

A further object of the present invention includes a voice-enabled, Bluetooth-enabled, hands-free telephone system for a vehicle in which the system audibly announces vehicle component information through vehicle speakers for a user to hear in response to a spoken request for such information from the user.

Another object of the present invention includes a voice-enabled, Bluetooth-enabled, hands-free telephone system having a phone mode in which the system wirelessly communicates with a Bluetooth-enabled cell phone in a vehicle to carry out a hands-free call involving the cell phone and an external party, and having a vehicle status information mode in which the system audibly announces vehicle status information through vehicle speakers for a user to hear in response to a spoken request for such information from the user.

In carrying out the above objects and other objects, the present invention provides a voice-enabled, hands-free telephone system for a vehicle. The system includes a communications bus, a speaker connected to the communications bus, and a vehicle component connected to the communications bus. The vehicle component monitors the current status of a condition and provides a vehicle component signal indicative of the current status of the condition to the communications bus. The system further includes an appliance connected to the communications bus. The appliance is operable for wirelessly communicating with a Bluetooth enabled phone in the vehicle. During a call between a user using the phone and an external party the appliance receives voice signals from the user and wirelessly communicates the voice signals of the user to the phone for transmission to the external party and the appliance wirelessly receives voice signals of the external party from the phone and outputs the voice signals of the external party to the speaker via the communications bus for the user to hear. In response to a spoken request of a user for the current status of the condition, the appliance obtains the vehicle component signal from the communications bus to determine the current status of the condition and audibly announces a computerized voice signal indicative of the current status of the condition through the speaker via the communications bus for the user to hear the current status of the condition.

Further, in carrying out the above objects and other objects, the present invention provides a voice-enabled, hands-free telephone system for a vehicle. The system includes a communications bus, a speaker connected to the communications bus, and vehicle components connected to the communications bus. Each vehicle component monitors the current status of a respective condition and provides a vehicle component signal indicative of the current status of the respective condition to the communications bus. The system further includes an appliance connected to the communications bus. The appliance is operable for wirelessly communicating with a Bluetooth enabled phone in the vehicle. During a call between a user using the phone and an external party the appliance receives voice signals from the user and wirelessly communicates the voice signals of the user to the phone for transmission to the external party and the appliance wirelessly receives voice signals of the external party from the phone and outputs the voice signals of the external party to the speaker via the communications bus for the user to hear. In response to a spoken request of a user for the current status of one of conditions, the appliance obtains the vehicle component signal corresponding to the condition from the communications bus to determine the current status of the condition and audibly announces a computerized voice signal indicative of the current status of the condition through the speaker via the communications bus for the user to hear the current status of the condition.

Also, in carrying out the above objects and other objects, the present invention provides a voice-enabled, hands-free telephone system for a vehicle having a communications bus, a speaker connected to the communications bus, and a vehicle component connected to the communications bus. The vehicle component monitors the current status of a condition and provides a vehicle component signal indicative of the current status of the condition to the communications bus.

The system includes an appliance connected to the communications bus, the appliance including a processor, a Bluetooth enabled communications module, a voice recognition unit, and a voice synthesizer. The communications module is operable for wirelessly communicating with a Bluetooth enabled phone in the vehicle. During a call between a user using the phone and an external party the communications module receives voice signals from the user and wirelessly communicates the voice signals of the user to the phone for transmission to the external party and the communications module wirelessly receives voice signals of the external party from the phone and outputs the voice signals of the external party to the speaker via the communications bus for the user to hear.

The voice recognition unit converts a spoken request of a user for the current status of the condition into a request signal. The request signal indicates that the user requests the current status of the condition. The voice recognition unit provides the request signal to the processor. In response to the request signal the processor obtains the vehicle component signal from the communications bus to determine the current status of the condition. The processor provides a processor signal indicative of the current status of the condition to the voice synthesizer. The voice synthesizer uses the processor signal to generate a computerized voice signal indicative of the current status of the condition. The voice synthesizer audibly announces the computerized voice signal through the speaker via the communications bus for the user to hear the current status of the condition.

The above features, and other features and advantages of the present invention as readily apparent from the following detailed descriptions thereof when taken in connection with the accompanying drawings.

### BRIEF DESCRIPTION OF THE DRAWINGS

FIG. 1 illustrates a block diagram of a voice-enabled hands-free telephone system of a vehicle in accordance with an embodiment of the present invention;

FIG. 2 illustrates a flowchart describing general operation of the telephone system while in a vehicle status information mode;

FIG. 3 illustrates a flowchart describing operation of the telephone system to audibly announce the current vehicle direction through the vehicle speakers for a user to hear in response to a spoken request for such information from the user while the telephone system is in the vehicle status information mode;

FIG. 4 illustrates a flowchart describing operation of the telephone system to audibly announce the current temperature outside the vehicle through the vehicle speakers for a user to hear in response to a spoken request for such information from the user while the telephone system is in the vehicle status information mode;

FIG. 5 illustrates a flowchart describing operation of the telephone system to audibly announce the current time through the vehicle speakers for a user to hear in response to a spoken request for such information from the user while the telephone system is in the vehicle status information mode;

FIG. 6 illustrates a flowchart describing operation of the telephone system to audibly announce the current vehicle speed through the vehicle speakers for a user to hear in response to a spoken request for such information from the user while the telephone system is in the vehicle status information mode; and

FIG. 7 illustrates a block diagram of a vehicle system in accordance with an embodiment of the present invention.

### DETAILED DESCRIPTION OF THE PREFERRED EMBODIMENT(S)

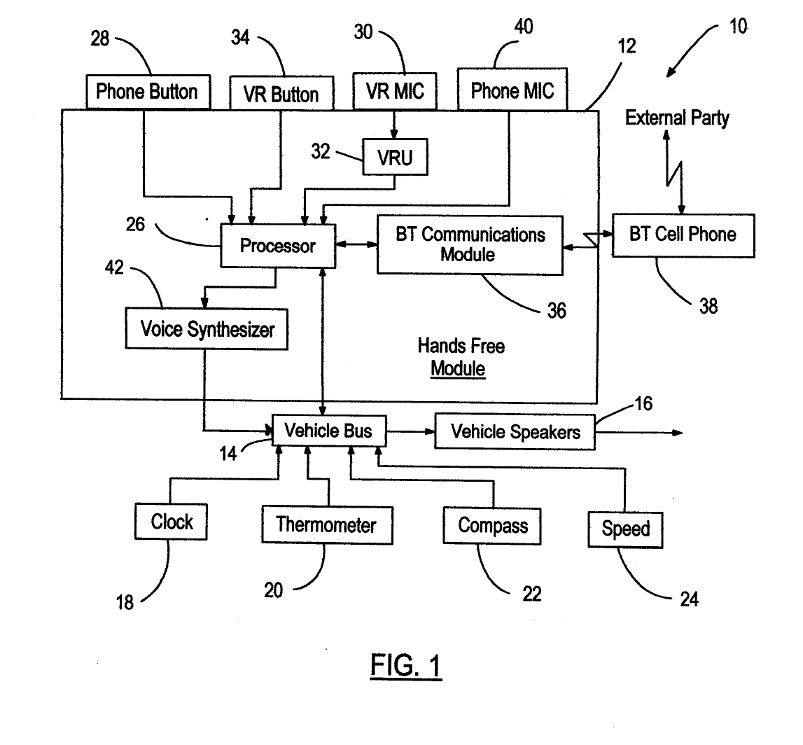

Referring now to FIG. 1, a block diagram of a voice-enabled hands-free telephone system 10 of a vehicle in accordance with an embodiment of the present invention is shown. Telephone system 10 includes an appliance 12. Appliance 12 is part of a module that is integrated into the vehicle. Appliance 12 is operable in a phone mode and a vehicle status information mode. In the phone mode, appliance 12 enables a user to have a phone conversation via a cell phone in the vehicle while using both hands to drive the vehicle. In the vehicle status information mode, appliance 12 obtains information (e.g., time, temperature outside of the vehicle, vehicle direction, vehicle speed, etc.) monitored by a vehicle component (e.g., clock, thermometer, compass, speedometer, etc.) in response to a spoken request for such information from a user and then audibly announces the information through the speakers of the vehicle for the user to hear.

A data communications bus 14 runs through the vehicle and interconnects a variety of components within the vehicle. Many standards exist for specifying bus operations such as, for example, SAE J 1850, Controller Area Network (CAN), and the like. Various manufacturers provide bus interfaces that handle low level signaling, handshaking, protocol implementation, and other bus communication operations.

Appliance 12 is connected to bus 14 to be in communication with other vehicle components connected to the bus. In this embodiment of the present invention, other vehicle components connected to bus 14 include vehicle speakers 16, clock 18, thermometer 20, compass 22, and speedometer 24. Speakers 16 are operable to output audible sounds including music from a radio of the vehicle. Clock 18 monitors the current time. Thermometer 20 monitors the temperature outside of the vehicle. Compass 22 monitors the current vehicle direction. Speedometer 24 monitors the current vehicle speed.

Bus 14 transfers information monitored by clock 18, thermometer 20, compass 22, and/or speedometer 24 to appliance 12 for the appliance to audibly output through speakers 16 for the user to hear in response to the user speaking a request for such information while the appliance is in the vehicle status information mode. As such, the user hears the monitored information requested by the user instead of visually seeing such information on a display. A brief example is as follows. The user requests information regarding the current direction of the vehicle by speaking the a phrase containing “compass”, “vehicle direction”, etc., while appliance 12 is in the vehicle status information mode. In turn, appliance 12 obtains the current vehicle direction (e.g., north) from compass 22 via bus 14 and then audibly announces the word “North” through speakers 16 via bus 14 for the user to hear.

Appliance 12 includes a processor 26. Processor 26 controls and enables the overall operation of telephone system 10. Processor 26 places appliance 12 in the phone mode upon: a user actuating a phone button 28 of the appliance; detection of an incoming call to the user; a user speaking certain phone commands into a voice-recognition (VR) microphone 30 of the appliance. With respect to the last option, appliance 12 includes a voice recognition unit (VRU) 32. VRU 32 in conjunction with other elements of appliance 12 enables a user to speak phone commands for answering and making cell phone calls and re-dialing numbers via a cell phone instead of manually handling the cell phone to do so. VRU 32 is connected to VR microphone 30 to receive the phone commands spoken by the user. VRU 32 converts the spoken phone commands into corresponding electrical signals for use by processor 26. For example, VRU 32 translates the phone command “dial” into a corresponding signal; translates numeric characters spoken by the user into corresponding signals; etc.

Regarding the operation of appliance 12 in the phone mode, the appliance includes a Bluetooth enabled communications module 36. Communications module 36 is operable for wirelessly communicating with Bluetooth enabled devices such as a Bluetooth enabled cell phone 38 in the vehicle. Communications module 36 wirelessly communicates with cell phone 38 during a call over a telecommunications network between a user using the cell phone and an external party while appliance 12 is in the phone mode. Operation of appliance 12 during the call is as follows. The user audibly talks out loud in the vehicle during the call just like the user would talk into cell phone 38 during the call. A phone microphone 40 of appliance 12 converts the audible sounds of the user into corresponding electrical voice signals. Phone microphone 40 is connected to communications module 36 via processor 26 or is directly connected to the communications module. In any event, communications module 36 receives the voice signals from the user via phone microphone 40 and wirelessly communicates the voice signals to cell phone 38 for transmission over the telecommunications network for receipt by the external party. Likewise, during the call, communications module 36 wirelessly receives the voice signals from the external party from cell phone 38 and outputs the voice signals of the external party through speakers 16 for the user to hear.

Processor 26 places appliance 12 in the vehicle status information mode upon a user manually actuating a voice-recognition (VR) button 34 of appliance 12. Processor 26 places appliance 12 in the vehicle status information mode upon a user speaking certain appliance commands into VR microphone 30 of the appliance. For example, processor 26 places appliance 12 in the vehicle status information mode upon the user speaking the command “vehicle status information mode”.

Regarding the operation of appliance 12 in the vehicle status information mode, the appliance includes a voice synthesizer 42 in addition to VRU 32. Voice synthesizer 42 generates computerized voice signals of information monitored by clock 18, thermometer 20, compass 22, and speedometer 24 for speakers 16 to output for the user to hear. As such, the user hears such information instead of visually seeing this information on a display.

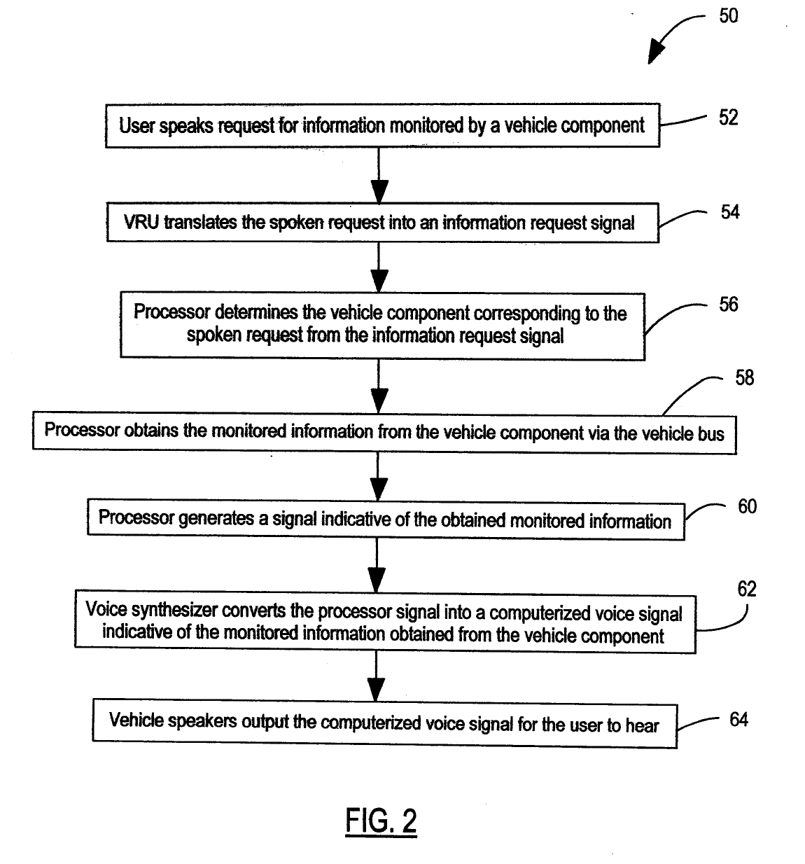

Referring now to FIG. 2, with continual reference to FIG. 1, a flowchart 50 describing general operation of telephone system 10 while in the vehicle status information mode is shown. Again, telephone system 10 is in this mode in response to the user speaking a command such as “vehicle status information mode” into VR microphone 30 and/or actuating VR button 34.

Initially, a user speaks a request for information monitored by a vehicle component into VR microphone 30 as shown in block 52. For example, a spoken request of the user may be a question such as “What is the ______?” where “______” is any one of “vehicle direction”; “temperature”; “time”; “vehicle speed”; etc. VRU 32 translates the spoken request into a corresponding information request signal for use by processor 26 as shown in block 54. Processor 26 uses the information request signal to determine the vehicle component (i.e., compass 22, thermometer 20, clock 18, or speedometer 24) corresponding to the request as shown in block 56. That is, processor 26 uses the information request signal to determine which vehicle component is responsible for the requested information. Processor 26 then communicates with the determined vehicle component via bus 14 to obtain the requested information as shown in block 58. Processor 26 then provides a signal indicative of the obtained information to voice synthesizer 42 as shown in block 60. Voice synthesizer 42 converts the signal indicative of the information into a corresponding computerized voice signal and transfers the computerized voice signal to speakers 16 via bus 14 as shown in block 62. Speakers 16 output the computerized voice signal of the requested information for the user to hear as shown in block 64.

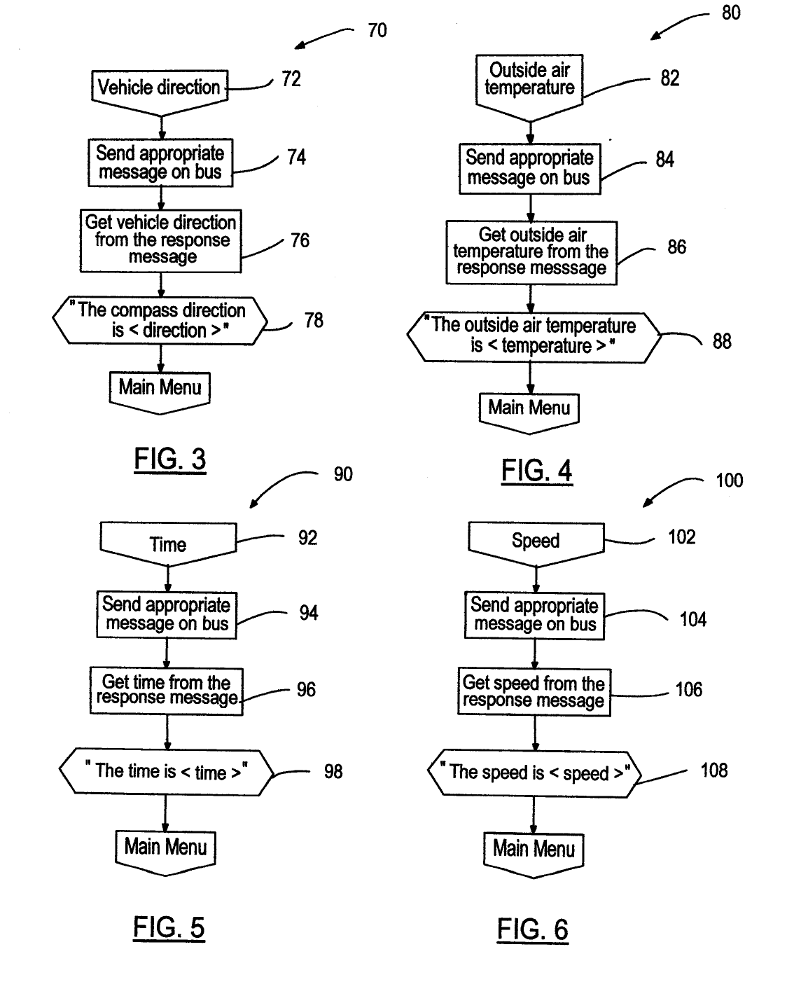

Referring now to FIG. 3, with continual reference to FIGS. 1 and 2, a flowchart 70 describing operation of telephone system 10 to audibly announce the current vehicle direction through speakers 16 for a user to hear in response to a spoken request for such information from the user is shown. A user requests information regarding the current vehicle direction by speaking, for example, an inquiry containing the word “compass” into VR microphone 30. VRU 32 translates the spoken inquiry into a compass information request signal. Processor 26 analyzes this request signal to determine that the user desires information regarding the current vehicle direction as shown in block 72. Processor 26 then transfers a request over bus 14 for the current vehicle direction monitored by compass 22 as shown in block 74. In response, information indicative of the current vehicle direction as monitored by compass 22 is transferred to processor 26 via bus 14 as shown in block 76. Processor 26 generates a signal indicative of the current vehicle direction for use by voice synthesizer 42. Voice synthesizer 42 converts this signal into a computerized voice signal and transfers the computerized voice signal to speakers 16 via bus 14. For example, the computerized voice signal is “The compass direction is <direction>”, where <direction> is the current vehicle direction as monitored by compass 22. Speakers 16 output the computerized voice signal for the user to hear as shown in block 78.

Referring now to FIG. 4, with continual reference to FIGS. 1 and 2, a flowchart 80 describing operation of telephone system 10 to audibly announce the current temperature outside of the vehicle through speakers 16 for a user to hear in response to a spoken request for such information from the user while telephone system 10 is in the vehicle status information mode is shown. A user requests information regarding the current temperature by speaking, for example, an inquiry containing the word “temperature” into VR microphone 30. VRU 32 translates the spoken inquiry into a temperature information request signal. Processor 26 analyzes this request signal to determine that the user desires information regarding the current temperature outside of the vehicle as shown in block 82. Processor 26 then transfers a request over bus 14 for the current temperature monitored by thermometer 20 as shown in block 84. In response, information indicative of the current temperature as monitored by thermometer 20 is transferred to processor 26 via bus 14 as shown in block 86. Processor 26 generates a signal indicative of the current temperature for use by voice synthesizer 42. Voice synthesizer 42 converts this signal into a computerized voice signal and transfers the computerized voice signal to speakers 16 via bus 14. For example, the computerized voice signal is “The outside air temperature is <temperature>”, where <temperature> is the current temperature outside of the vehicle as monitored by thermometer 20. Speakers 16 output the computerized voice signal for the user to hear as shown in block 88.

Referring now to FIG. 5, with continual reference to FIGS. 1 and 2, a flowchart 90 describing operation of telephone system 10 to audibly announce the current time through speakers 16 for a user to hear in response to a spoken request for such information from the user while telephone system 10 is in the vehicle status information mode is shown. A user requests information regarding the current time by speaking, for example, an inquiry containing the word “time” into VR microphone 30. VRU 32 translates the spoken inquiry into a time information request signal. Processor 26 analyzes this request signal to determine that the user desires information regarding the current time as shown in block 92. Processor 26 then transfers a request over bus 14 for the current time monitored by clock 18 as shown in block 94. In response, information indicative of the current time as monitored by clock 18 is transferred to processor 26 via bus 14 as shown in block 96. Processor 26 generates a signal indicative of the current time for use by voice synthesizer 42. Voice synthesizer 42 converts this signal into a computerized voice signal and transfers the computerized voice signal to speakers 16 via bus 14. For example, the computerized voice signal is “The time is <time>”, where <time> is the current time as monitored by clock 18. Speakers 16 output the computerized voice signal for the user to hear as shown in block 98.

Referring now to FIG. 6, with continual reference to FIGS. 1 and 2, a flowchart 100 describing operation of telephone system 10 to audibly announce the current vehicle speed through speakers 16 for a user to hear in response to a spoken request for such information from the user while telephone system 10 is in the vehicle status information mode is shown. A user requests information regarding the current vehicle speed by speaking, for example, an inquiry containing the “speed” into VR microphone 30. VRU 32 translates the spoken inquiry into a vehicle speed information request signal. Processor 26 analyzes this request signal to determine that the user desires information regarding the current vehicle speed as shown in block 102. Processor 26 then transfers a request over bus 14 for the current vehicle speed monitored by speedometer 24 as shown in block 104. In response, information indicative of the current vehicle speed as monitored by speedometer 24 is transferred to processor 26 via bus 14 as shown in block 106. Processor 26 generates a signal indicative of the current vehicle speed for use by voice synthesizer 42. Voice synthesizer 42 converts this signal into a computerized voice signal and transfers the computerized voice signal to speakers 16 via bus 14. Speakers 16 output the computerized voice signal indicative of the current vehicle speed for the user to hear as shown in block 108. For example, the computerized voice signal is “The vehicle speed is <speed>”, where <speed> is the current speed as monitored by speedometer 24. Speakers 16 output the computerized voice signal for the user to hear as shown in block 108.

Similarly, information from other vehicle components which are in communication with appliance 12 either directly or via bus 14 may be audibly announced by the appliance for a user to hear in response to spoken requests for such information by the user.

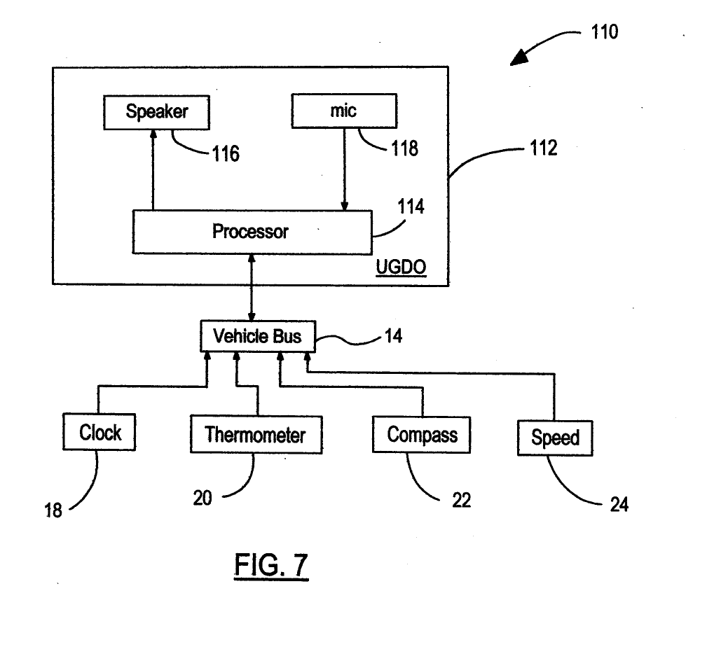

Referring now to FIG. 7, with continual reference to FIGS. 1 through 6, a block diagram of a vehicle system 110 in accordance with an embodiment of the present invention is shown. Vehicle system 110 includes a universal garage door opener (UGDO) appliance 112. Appliance 112 is operable in a garage door control mode and a vehicle status information mode. In the garage door control mode, appliance 112 generates and wirelessly transmits control signals in response to user actuation to open and close a garage door and the like. In the vehicle status information mode, appliance 112 obtains and audibly announces information monitored by a vehicle component(s). In the same manner as telephone system 10, appliance 112 obtains and announces vehicle component information in response to a spoken request for such information from a user. Likewise, appliance 112 obtains and announces vehicle component information in response to a user requesting such information by actuating a button or the like of appliance 112. Alternatively or additionally, appliance 112 automatically obtains and announces vehicle component information without a request (either spoken or manual button activation) for such information from a user. In the latter scenario, appliance 112 automatically obtains and announces vehicle component information when certain criteria or special events occur. For instance, appliance 112 automatically obtains and announces information regarding the current time or the outside air temperature when the vehicle is initially started. As another example, appliance 112 automatically obtains and announces information regarding the current vehicle speed when the vehicle speed exceeds a given threshold.

Appliance 112 includes a processor 114. Processor 114 generates the garage door control signals when appliance 112 is in the garage door control mode.

Processor 114 is connected to vehicle bus 14 to obtain vehicle component information from vehicle components (e.g., clock 18, thermometer 20, compass 22, speedometer 24, etc.) when appliance 112 is in the vehicle status information mode. Appliance 112 includes its own speaker 116 and microphone 118. Processor 114 generates a computerized voice signal indicative of the obtained vehicle component information and provides the signal to speaker 116 for the speaker to audibly announce to a user. Processor 114 obtains the vehicle component information in response to microphone 118 receiving a spoken request by a user for such information. To this end, processor 114 includes a VRU for translating the spoken request to determine the vehicle component information desired by the user. Appliance 112 further includes a button or the like to enable a user to submit a request for vehicle component information manually by pressing the button instead speaking a request for such information into microphone 118. As indicated, processor 112 may automatically obtain information from the vehicle components via vehicle bus 14 and announce such information through speaker 116 for a user to hear without the user requesting such information. This may occur during certain time periods (e.g., during initial starting/stopping of the vehicle), at special events (e.g., when certain vehicle component thresholds are reached), periodically every hour, etc. Further, appliance 112 may include its own voice synthesizer and/or VRU in the same manner as telephone system 10 for use in obtaining vehicle component information requests from users and/or audibly announcing obtained vehicle component information.

While embodiments of the present invention have been illustrated and described, it is not intended that these embodiments illustrate and describe all possible forms of the present invention. Rather, the words used in the specification are words of description rather than limitation, and it is understood that various changes may be made without departing from the spirit and scope of the present invention.

What is claimed is:

1. A voice-enabled, hands-free telephone system for a vehicle, the system comprising:
a communications bus;
a speaker connected to the communications bus;
a vehicle component connected to the communications bus, wherein the vehicle component monitors the current status of a condition and provides a vehicle component signal indicative of the current status of the condition to the communications bus;
an appliance connected to the communications bus;
wherein the appliance is operable for wirelessly communicating with a Bluetooth enabled phone in the vehicle, wherein during a call between a user using the phone and an external party the appliance receives voice signals from the user and wirelessly communicates the voice signals of the user to the phone for transmission to the external party and the appliance wirelessly receives voice signals of the external party from the phone and outputs the voice signals of the external party to the speaker via the communications bus for the user to hear;
wherein in response to a spoken request of a user for the current status of the condition the appliance obtains the vehicle component signal from the communications bus to determine the current status of the condition and audibly announces a computerized voice signal indicative of the current status of the condition through the speaker via the communications bus for the user to hear the current status of the condition.

2. The system of claim 1 wherein:
the vehicle component is a clock for monitoring the current time and the vehicle component signal is a clock signal indicative of the current time;
wherein in response to a spoken request of a user for the current time the appliance obtains the clock signal from the communications bus to determine the current time and audibly announces a computerized voice signal indicative of the current time through the speaker via the communications bus for the user to hear the current time.

3. The system of claim 1 wherein:
the vehicle component is a thermometer for monitoring the current temperature outside of the vehicle and the vehicle component signal is a thermometer signal indicative of the current temperature outside of the vehicle;
wherein in response to a spoken request of a user for the current temperature outside of the vehicle the appliance obtains the thermometer signal from the communications bus to determine the current temperature outside of the vehicle and audibly announces a computerized voice signal indicative of the current temperature outside of the vehicle through the speaker via the communications bus for the user to hear the current temperature outside of the vehicle.

4. The system of claim 1 wherein:
the vehicle component is a compass for monitoring the current direction of the vehicle and the vehicle component signal is a compass signal indicative of the current direction of the vehicle;
wherein in response to a spoken request of a user for the current direction of the vehicle the appliance obtains the compass signal from the communications bus to determine the current direction of the vehicle and audibly announces a computerized voice signal indicative of the current direction of the vehicle through the speaker via the communications bus for the user to hear the current direction of the vehicle.

5. The system of claim 1 wherein:
the vehicle component is a speedometer for monitoring the current speed of the vehicle and the vehicle component signal is a speedometer signal indicative of the current speed of the vehicle;
wherein in response to a spoken request of a user for the current speed of the vehicle the appliance obtains the speedometer signal from the communications bus to determine the current speed of the vehicle and audibly announces a computerized voice signal indicative of the current speed of the vehicle through the speaker via the communications bus for the user to hear the current speed of the vehicle.

6. The system of claim 1 wherein:
the appliance includes a Bluetooth enabled communications module operable for wirelessly communicating with a Bluetooth enabled phone in the vehicle, wherein during a call between a user using the phone and an external party the communications module receives voice signals from the user and wirelessly communicates the voice signals of the user to the phone for transmission to the external party and the communications module wirelessly receives voice signals of the external party from the phone and outputs the voice signals of the external party to the speaker via the communications bus for the user to hear.

7. The system of claim 1 wherein:
the appliance includes a voice recognition unit, wherein the voice recognition unit converts the spoken request of the user for the current status of the condition into a request signal requesting the vehicle component signal, wherein the appliance provides the request signal to the communications bus to obtain the vehicle component signal from the communications bus.

8. The system of claim 1 wherein:
the appliance includes a voice synthesizer for audibly announcing the computerized voice signal indicative of the current status of the condition through the speaker via the communications bus for the user to hear the current status of the condition.

9. The system of claim 1 wherein:
the appliance further includes a microphone for receiving the spoken request of the user for the current status of the condition.

10. The system of claim 1 wherein:
the appliance further includes a button which indicates to the appliance upon actuation that the appliance is to listen for the spoken request for the current status of the condition from the user.

11. A voice-enabled, hands-free telephone system for a vehicle, the system comprising:
a communications bus;
a speaker connected to the communications bus;
a plurality of vehicle components connected to the communications bus, wherein each vehicle component monitors the current status of a respective condition and provides a vehicle component signal indicative of the current status of the respective condition to the communications bus;
an appliance connected to the communications bus;
wherein the appliance is operable for wirelessly communicating with a Bluetooth enabled phone in the vehicle, wherein during a call between a user using the phone and an external party the appliance receives voice signals from the user and wirelessly communicates the voice signals of the user to the phone for transmission to the external party and the appliance wirelessly receives voice signals of the external party from the phone and outputs the voice signals of the external party to the speaker via the communications bus for the user to hear;
wherein in response to a spoken request of a user for the current status of one of conditions the appliance obtains the vehicle component signal corresponding to the condition from the communications bus to determine the current status of the condition and audibly announces a computerized voice signal indicative of the current status of the condition through the speaker via the communications bus for the user to hear the current status of the condition.

12. The system of claim 11 wherein:
the vehicle components include a clock for monitoring the current time and providing a clock signal indicative of the current time to the communications bus, a thermometer for monitoring the current temperature outside of the vehicle and providing a thermometer signal indicative of the current temperature outside of the vehicle, a compass for monitoring the current direction of the vehicle and providing a compass signal indicative of the current direction of the vehicle, and a speedometer for monitoring the current speed of the vehicle and providing a speedometer signal indicative of the current speed of the vehicle;
wherein in response to a spoken request of a user for the current time the appliance obtains the clock signal from the communications bus to determine the current time and audibly announces a computerized voice signal indicative of the current time through the speaker via the communications bus for the user to hear;
wherein in response to a spoken request of a user for the current temperature outside of the vehicle the appliance obtains the thermometer signal from the communications bus to determine the current temperature outside of the vehicle and audibly announces a computerized voice signal indicative of the current temperature outside of the vehicle through the speaker via the communications bus for the user to hear;
wherein in response to a spoken request of a user for the current direction of the vehicle the appliance obtains the compass signal from the communications bus to determine the current direction of the vehicle and audibly announces a computerized voice signal indicative of the current direction of the vehicle through the speaker via the communications bus for the user to hear;
wherein in response to a spoken request of a user for the current speed of the vehicle the appliance obtains the speedometer signal from the communications bus to determine the current speed of the vehicle and audibly announces a computerized voice signal indicative of the current speed of the vehicle through the speaker via the communications bus for the user to hear.

13. The system of claim 11 wherein:
the appliance includes a Bluetooth enabled communications module operable for wirelessly communicating with a Bluetooth enabled phone in the vehicle, wherein during a call between a user using the phone and an external party the communications module receives voice signals from the user and wirelessly communicates the voice signals of the user to the phone for transmission to the external party and the communications module wirelessly receives voice signals of the external party from the phone and outputs the voice signals of the external party to the speaker via the communications bus for the user to hear.

14. The system of claim 11 wherein:
the appliance includes a voice recognition unit, wherein the voice recognition unit converts the spoken request of the user for the current status of the condition into a request signal requesting the vehicle component signal, wherein the appliance provides the request signal to the communications bus to obtain the vehicle component signal from the communications bus.

15. The system of claim 11 wherein:
the appliance includes a voice synthesizer for audibly announcing the computerized voice signal indicative of the current status of the condition through the speaker via the communications bus for the user to hear the current status of the condition.

16. The system of claim 11 wherein:
the appliance further includes a microphone for receiving the spoken request of the user for the current status of the condition.

17. The system of claim 11 wherein:
the appliance further includes a button which indicates to the appliance upon actuation that the appliance is to listen for the spoken request for the current status of the condition from the user.

18. A voice-enabled, hands-free telephone system for a vehicle having a communications bus, a speaker connected to the communications bus, and a vehicle component connected to the communications bus, wherein the vehicle component monitors the current status of a condition and provides a vehicle component signal indicative of the current status of the condition to the communications bus, the system comprising:
an appliance connected to the communications bus, the appliance including a processor, a Bluetooth enabled communications module, a voice recognition unit, and a voice synthesizer;
wherein the communications module is operable for wirelessly communicating with a Bluetooth enabled phone in the vehicle, wherein during a call between a user using the phone and an external party the communications module receives voice signals from the user and wirelessly communicates the voice signals of the user to the phone for transmission to the external party and the communications module wirelessly receives voice signals of the external party from the phone and outputs the voice signals of the external party to the speaker via the communications bus for the user to hear;
wherein the voice recognition unit converts a spoken request of a user for the current status of the condition into a request signal, wherein the request signal indicates that the user requests the current status of the condition, wherein the voice recognition unit provides the request signal to the processor;
wherein in response to the request signal the processor obtains the vehicle component signal from the communications bus to determine the current status of the condition, wherein the processor provides a processor signal indicative of the current status of the condition to the voice synthesizer;
wherein the voice synthesizer uses the processor signal to generate a computerized voice signal indicative of the current status of the condition, wherein the voice synthesizer audibly announces the computerized voice signal through the speaker via the communications bus for the user to hear the current status of the condition.

19. The system of claim 18 wherein:
the vehicle component is a compass for monitoring the current direction of the vehicle and the vehicle component signal is a compass signal indicative of the current direction of the vehicle;
wherein in response to a spoken request of a user for the current direction of the vehicle the processor obtains the compass signal from the communications bus to determine the current direction of the vehicle and the voice synthesizer audibly announces a computerized voice signal indicative of the current direction of the vehicle through the speaker via the communications bus for the user to hear the current direction of the vehicle.

20. The system of claim 18 wherein:
the vehicle component is a speedometer for monitoring the current speed of the vehicle and the vehicle component signal is a speedometer signal indicative of the current speed of the vehicle;
wherein in response to a spoken request of a user for the current speed of the vehicle the processor obtains the speedometer signal from the communications bus to determine the current speed of the vehicle and the voice synthesizer audibly announces a computerized voice signal indicative of the current speed of the vehicle through the speaker via the communications bus for the user to hear the current speed of the vehicle.
